(19) United States
(12) Patent Application Publication
(10) Pub. No.: US 2014/0261229 A1
(43) Pub. Date: Sep. 18, 2014

(54) Ring-Like Element Structured To Be Connected With Other Structures

(71) Applicant: Doskocil Manufacturing Company, Inc., Arlington, VA (US)

(72) Inventors: Zeng Yi Bao, Tanzhou (CN); Jack William Renforth, Arlington, TX (US)

(73) Assignee: Doskocil Manufacturing Company, Inc., Arlington, VA (US)

(21) Appl. No.: 13/828,000

(22) Filed: Mar. 14, 2013

(51) Int. Cl. A01K 15/02; B29C 45/00

(52) U.S. Cl. CPC A01K 15/025; B29C 45/0017
USPC 119/707; 264/263

(57) ABSTRACT

An improved method of forming a structure out of a polymer such as TPR includes forming a body that is molded to include at least a portion of a connector, interconnecting the portion of the connector with a cooperative other portion of the connector, and overmolding the connected portions of the connector with a polymeric material to retain the connector in its connected configuration. This enables, for example, a link of a chain to be formed from an elongated body having at its ends cooperable connector portions that are connectable together to form a ring-like structure which is substantially continuous about its longitudinal extent. The connector is then overmolded with a polymeric material, which may be the same material from which the elongated body is formed or another material, in order to retain the portions of the connector in the connected configuration.

### BACKGROUND

1. Field

The disclosed and claimed concept relates generally to pet toys and, more particularly, to a ring-like element that can be connected with other structures having a hole formed therein to form a chain that can be employed as a pet toy.

2. Related Art

Numerous types of toys for animals are known in the relevant art. Such toys may include, by way of example, retrieval toys (i.e., a ball that a dog would retrieve after the ball was thrown), interest toys (such as a rubber mouse with which a cat may play), and chew toys (such as artificial bones for chewing by dogs and tug toys), among other types of toys. Nearly all such animal toys are configured in one fashion or another to draw and retain the interest of the animal in order to encourage the animal to interact with the toy. While such toys have been generally effective for their intended purposes, they have not been without limitation.

Animal toys are desirably robust and are configured to resist destruction by an animal during ordinary usage. One type of material that has been advantageously employed to form animal toys is thermoplastic rubber (TPR) which is a moldable polymer which possesses many of the advantages of injection molded plastic as well as many of the characteristics of rubber. For instance, TPR possesses both thermoplastic and elastomeric properties and thus is well suited to a punishing environment in which it will be interacted with by an animal. It is known, however, that TPR can be difficult to mold (i.e., form). Moreover, the formation of a structure having multiple parts, at least one of which is formed of TPR, has been difficult because TPR has been known to interact in an unreliable fashion with adhesives, by way of example. It thus would be desirable to provide an improved method of enabling the formation of animal toys and other structures that are formed at least in part of certain polymers, including TRP.

### SUMMARY

In view of the foregoing, an improved method of forming a structure out of a polymer such as TPR includes forming a body that is molded to include at least a portion of a connector, interconnecting the portion of the connector with a cooperative other portion of the connector, and overmolding the connected portions of the connector with a polymeric material to retain the connector in its connected configuration. This enables, for example, a link of a chain to be formed from an elongated body having at its ends cooperable connector portions that are connectable together to form a ring-like structure which is substantially continuous about its longitudinal extent. The connector is then overmolded with a polymeric material, which may be the same material from which the elongated body is formed, in order to retain the portions of the connector in the connected configuration. This advantageously allows the elongated body to be connected with other structures having a hole formed therein. By way of example, the body could be linked with one or more other ring-shaped structures having a hole formed therein by receiving an end of the elongated body through the hole, connecting together the connector portions, and forming the overmold thereon.

Accordingly, as aspect of the disclosed and claimed concept is to provide an improved polymeric element that is structured to be attached to another structure having a hole formed therein.

Another aspect of the disclosed and claimed concept is to provide an improved ring-like element that is formed from an elongated body having cooperable portions of a connector at its ends, with the connector portions being connected together and having an overmold formed thereon to resist disconnection of the connector portions.

Another aspect of the disclosed and claimed concept is to provide an improved chain of connected elements that comprise the aforementioned ring-like element that is connected together with a number of other structures that each have a hole formed therein, with the ring-like element being linked together with the other structures at the holes thereof.

Another aspect of the disclosed and claimed concept is to provide an improved method of attaching a ring-like element to another structure having a hole formed therein.

Another aspect of the disclosed and claimed concept is to provide an improved method of forming a body out of a polymeric material wherein the body can be reliably connected with another structure and withstand an environment that includes animals.

Accordingly, as an aspect of the disclosed and claimed concept is to provide an improved element structured to be attached to another structure having a hole formed therein, the general nature of which can be stated as including a connector and an elongated body. The connector can be stated as including a first portion and a second portion that are connectable together. The elongated body has as a first end the first portion and has as a second end the second portion, one of the first end and the second end being structured to be received in the hole formed in the other structure prior to connection with the other of the first end and the second end. The connector is structured to receive a layer of material applied to an exterior thereof when the first and second portions are connected together. The body is structured to be of a ring-like configuration that is substantially continuous about its longitudinal extent when the first and second portions are connected together and the layer of material is received on the connector.

Other aspects of the disclosed and claimed concept are provided by an improved ring-like element the general nature of which can be stated as including a connector, an elongated body, and a layer of material. The connector can be generally stated as including a first portion and a second portion. The elongated body has as a first end the first portion and has as a second end the second portion, the first and second portions being connected together to cause the body to be of a ring-like configuration that is substantially continuous about its longitudinal extent. The layer of material is situated on an exterior of the connecter and is structured to resist disconnection of the first and second portions.

Other aspects of the disclosed and claimed concept are provided by an improved method of attaching a ring-like element to another structure having a hole formed therein, wherein the method can be generally stated as including receiving through the hole one of a first end and a second end of an elongated body which has as the first end a first portion of a connector and which has as the second end a second portion of the connector, connecting together the first and second portions, and receiving on an exterior of the connected together first and second portions of the connector a layer of material to resist disconnection of the first and second portions.

### BRIEF DESCRIPTION OF THE DRAWINGS

A further understanding of the disclosed and claimed concept can be gained from the following Description when read in conjunction with the accompany drawings in which:

FIG. 1 is a depiction of a chain of linked-together elements wherein at least one of the elements is a ring-like element in accordance with the disclosed and claimed concept;

FIG. 2 depicts a linkable element from which the ring-like element of FIG. 1 can be formed;

FIG. 3 is a view of an end of the linkable element of claim 2;

FIG. 4 is an view of another end of the linkable element of claim 2;

FIG. 5 is a schematic depiction of the portions of a connector of the linkable element of claim 2 in a disconnected condition being moved together in a connection direction;

FIG. 6 depicts the linkable element of FIG. 2 with the portions of its connector of FIG. 5 being in a connected configuration;

FIG. 7 is a schematic view depicting the connector of FIG. 5 in the connected configuration and having as an overmold a layer of material formed on an exterior surface of the connector;

FIG. 8 is a flowchart depicting certain aspects of an improved method in accordance with the disclosed and claimed concept; and

FIG. 9 is another flowchart depicting certain aspects of the improved method.

Similar numerals refer to similar parts throughout the specification.

### DESCRIPTION

An improved ring 2 is depicted in FIG. 1 and is shown as being connected together with another structure 4 having a hole 6 formed therein to form a chain 8 of linked-together elements. The ring 2 is generally described as being ring-like, although the expression “ring-like” is intended to refer generally to an elongated body that is connected with itself in one fashion or another, for instance, and that is therefore substantially structurally continuous about its longitudinal extent. The expression “ring-like” in not intended to imply that the element is necessarily to be of a circular profile, or to have any particular cross-sectional shape or to have unvarying cross-sectional dimensions about its longitudinal extent, and in this regard it can be seen that the ring 2 is depicted in FIG. 1 as being of a generally triangular profile and having regions of greater and lesser cross-sectional dimensions about its longitudinal extent. A ring-like structure will generally include some type of hole, such as the hole 9 in the ring 2, although this is not necessarily a requirement of a ring-like element. As will be set forth in greater detail below, the ring 2 is advantageously configured to enable it to be linked with a number of other structures that each have a hole formed therein and through which at least a portion of the ring 2 is receivable. As employed herein, the expression “a number of” and variations thereof shall refer broadly to any non-zero quantity, including a quantity of one.

The ring 2 of FIG. 1 can be said to include a linkable element 10 (which is more expressly depicted in FIGS. 2 and 6) and a layer of material (FIGS. 1 and 7) that extends across a portion of the linkable element 10. More particularly, the linkable element 10 can be said to include an elongated body 16 and a connector 20, with the layer of material 12 being situated on the connector 20 in its connected configuration. That is, the connector 20 can be said to include two cooperable portions which, in the depicted exemplary embodiment, are in the form of a male portion 24 and a female portion 28 that are movable between a disconnected configuration (FIGS. 2 and 5) and a connected configuration (FIGS. 6 and 7), with the layer of material 12 being situated on the connector 20 in its connected configuration.

The elongated body 16 has as its opposite ends the male portion 24 and the female portion 28. That is, the elongated body 16 can be said to include a first end 32 and a second end 36 opposite thereto, with the first end 32 being the male portion 24, and with the second end 36 being the female portion 28.

In this regard, it is noted that the exemplary linkable element 10 is described herein as being formed as a unitary, single piece element which is substantially free of joint and which, in its free state, appears much like its depiction in FIG. 2. In the depicted exemplary embodiment, the linkable element 10 is formed by molding TPR in a mold having a cavity that corresponds with the shape of the linkable element as is depicted generally in FIG. 2. It thus can be seen that the linkable element 10 in its free state, i.e., such as immediately after it has been molded and as is depicted generally in FIG. 2, has the male portion 24 disconnected from the female portion 28. That is, in the free state of the linkable element 10, the connector 20 is in its disconnected configuration. In such a disconnected configuration of the connector 20, the linkable element can be said to be of a discontinuous configuration about its longitudinal extent because the disconnected male and female portions 24 and 28 cause a discontinuity in the structure. As will be set forth in greater detail below, however, the linkable element 10 is movable from the free state depicted generally in FIG. 2 to a state wherein the connector 20 is in a connected configuration, whereupon the layer of material 12 can be applied to an exterior surface of the connector 20, such as by molding of the layer of material 12 in another mold to be overmolded over the connector 20, or via other formation methodologies.

As can be seen in FIG. 3, the male portion 24 can be said to include a ledge 40 that is oriented generally in an azimuthal direction with respect to the direction of elongation of the elongated body 16. That is, the ledge 40 is oriented transverse to the longitudinal extent of the elongated body 16 and extends radially with respect to an imaginary center point situated at the center of the transverse dimensions of the elongated body 16 at a given point along its longitudinal extent. The ledge 40 is thus generally of an annular shape and is situated transverse to the longitudinal extent of the elongated body 16.

The male portion 24 further includes a boss 42 that extends in the longitudinal direction from the ledge 40. The male portion 24 further includes a projection 44 that protrudes in the longitudinal direction from a surface of the boss 42. The boss 42 includes a number of engagement structures 48 that are situated laterally about the boss 42 and extend away from the boss 42 in a direction transverse to the longitudinal extent of the elongated body 16. The male portion 24 also includes an exterior surface 52 that extends across a portion of the projection 44 and at least a portion of the boss 42.

The projection 44 includes a pair of retention structures 56, each of which has an abutment surface 60 which, in the depicted exemplary embodiment, extends in a direction generally transverse to the longitudinal extent of the elongated body 16. As will be set forth in greater detail below, the abutment surfaces 60 are configured to confront corresponding surfaces on the female portion 28 to resist movement of the connector 20 away from its connected configuration toward its disconnected configuration.

The female portion 28 can be said to include a boss 64 that likewise extends in a longitudinal direction from a ledge 66 of the elongated body 16 that is configured to be similar to the ledge 40. The boss 64 likewise has a number of engagement structures 68 that extend laterally from the boss 64 in a fashion similar to the engagement structures 48. The female portion 28 further includes an additional boss 72 that extends from the boss 64 and in which is formed a receptacle 76 that is structured to receive the projection 44 in the connected configuration of the connector 20. The female portion 28 additionally can be said to include an exterior surface 80 that extends across at least a portion of the additional boss 72, the engagement structures 68, and the boss 64.

The receptacle 76 is configured to include a pair of retention structures 84 that each include an abutment surface 88 that is oriented generally transverse to the longitudinal extent of the elongated body 16. The abutment surfaces 88 are engageable with the abutment surfaces 60 in order to resist movement of the connector 20 away from its connected configuration and toward its disconnected configuration, as has been suggested elsewhere herein.

The linkable element 10 is movable from the disconnected configuration depicted generally in FIGS. 2 and 5 to a connected configuration as is depicted generally in FIGS. 6 and 7 by receiving the projection 44 in the receptacle 76. In this regard, the retention structures 56 and 84 provide to the projection 44 and the receptacle 76 an interference fit which may require a given amount of force to cause the projection 44 to be fully received in the receptacle 76 whereupon the abutment surfaces 60 confront the abutment surfaces 88, as is depicted generally in FIGS. 6 and 7. If the connector 20 in its connected configuration is subjected to a tensile force such as would tend to move the male portion 24 away from the female portion 28 in a direction opposite the arrow depicted generally in FIG. 5, the confronting abutment surfaces 60 and 88 of the retention structures 56 and 84 would engage one another and would resist such disconnecting movement until the forces are sufficient to overcome the tensile strength of the materials that form the ring 2. The retention structures 56 and 84 thus confront one another in the connected configuration of the connector 20 and resist disconnection of the male and female portions 24 and 28. The connector 20 in its connected configuration thus causes the linkable element 10 to be in a ring-like condition wherein the elongated body 16 is structurally continuous about its longitudinal extent.

As suggested above, and to maintain the structural continuity of the linkable element 10 in its connected configuration, the connector 20 in its connected configuration (FIG. 6) is subjected to another formation operation wherein the layer of material 12 is applied to the exterior surfaces 52 and 80 of the connector 20. In the depicted exemplary embodiment, at least the connector 20 of the linkable element 10 in its connected configuration (FIG. 6) is received in another mold (not expressly depicted herein) whereupon the same material that is used to form the elongated body 16 (or another material, depending upon the needs of the application) is received in the mold and is caused to become molded about the connector 20 as is depicted generally in FIG. 7 in broken lines. Such a further molding operation causes the layer of material 12 to become molded to and thus effective adhered to the connector 20 in its connected configuration. In so doing, the layer of material is molded onto the exterior surfaces 52 and 80 of the connector 20, and the layer of material 12 is also molded to the engagement structures 48 and 68. When the layer of material 12 is cured, such as by cooling if the material from which the layer of material 12 is made is a thermoplastic material, the projection 44 received in the receptacle 76 resists both longitudinal and azimuthal movement of the male and female portions 24 and 28 with respect to one another. The engagement structures 48 and 68 likewise resist such longitudinal and azimuthal movement of the male and female portions 24 and 28 with respect to one another as a result of the engagement structures 48 and 68 having the layer of material 12 molded thereto. Moreover, the layer of material 12 molded to the exterior surfaces 52 and 80 of the connector 20 further resists at least longitudinal movement of the male and female portions 24 and 28 with respect to one another, and the confronting retention structures 56 and 84 further resist such longitudinal movement.

It is expressly noted that the linkable element 10 in its connected configuration as is depicted generally in FIG. 6 is, for purposes of clarity of disclosure, not depicted as being connected with any other structures. It is noted, however, that prior to the moving of the linkable element 10 from its disconnected configuration of FIG. 2 to its connected configuration of FIG. 6, the linkable element 10 would most likely have been linked with at least one other structure having a hole formed therein. Such linking would occur by receiving the male portion 24 or the female portion 28 through the hole and thereafter connecting together the male and female portions 24 and 28. That is, the linkable element 10 in its disconnected configuration can be linked with any of a variety of other structures by receiving the male portion 24 or the female portion 28 in a hole formed in the other structure and by thereafter receiving the projection 44 in the receptacle 76 to cause the connector 20 to be placed in its connected configuration. The layer of material 12 can be then be applied, such as by molding, on the connector 20.

The aforementioned structure and methodology thus advantageously enable one ring-like element such as the ring 2 to be linked with another structure having a hole formed therein. Such other structures may include one or more ring-like elements that may have been originally molded or otherwise formed to already be of a continuous configuration about the longitudinal extent thereof. That is, a three-link chain of elements (not expressly depicted herein) could be formed with the ring 2 in combination with a pair of ring-like structures that were originally molded in their ring-shaped configuration, i.e., being structurally continuous about their longitudinal extent. For example, the male portion 24 or the female portion 28 (of the connecter 20 in its disconnected configuration) can be received in the holes in each of such ring-like elements. The male and female portions 24 and 28 of the ring 2 can then be connected together and the layer of material 12 molded onto the connector 20 to place the ring 2 in a condition linked between the two other ring-like elements. However, only one of the three ring-like elements was needed to initially be fanned as a linkable element 10 in a disconnected condition, to have its male and female portions 24 and 28 connected together, and to have the layer of material 12 molded thereon. That is, a three link chain can be formed by performing the connecting and additional molding operations only with respect one of the three ring-like structures. This enables economically efficient manufacture.

The layer of material 12 applied to the connector 20 in its connected configuration secures the connector 20 in its connected configuration and advantageously imparts to the portion of the ring 2 where the connector 20 is situated a relatively higher tensile strength than the other portions of the ring 2. Moreover, if the layer of material 12 is formed of the same material from which the linkable element 10 is formed, the layer of material 12 and the underlying connector 20 can be difficult to visually discern, which advantageously enhances the visual desirability of the resultant structure.

In this regard, the ring 2 is advantageously formed to include a pair of indentations 92 and 96 formed in the ring 2 at the opposite ends of the layer of material 12. That is, the indentation 92 is situated generally between and adjacent at least one of the ledge 40 and the layer of material 12. The indentation 96 is likewise situated generally between and adjacent at least one of the ledge 66 and the layer of material 12. The indentations 92 and 96 are formed in at least one of the elongated body 16 and the layer of material 12 and can be said to extend azimuthally about the cross-sectional periphery of the ring 2 in a direction generally transverse to its longitudinal extent.

Such indentations 92 and 96 provide a small visual discontinuity between the exterior surface of the layer of material 12 and the exterior surface of the elongated body 16, and the indentations 92 and 96 thus make a visual identification of the layer of material 12 even more difficult. This further enhances the visual desirability of the ring 2 and the chain 8. It is noted, however, that the ring 2 can be formed without the indentations 92 and 96 without departing from the present concept, and the layer of material 12 will still be difficult to visually discern, which is still highly desirable.

Certain aspects of a method of forming the ring 2 are depicted with a flowchart that is shown generally in FIG. 8. The method can be said to begin with the molding of the linkable element 10, as at the numeral 114, by receiving molten material in a mold (not expressly depicted herein) having a cavity in the shape of the linkable element 10 as is depicted in its free state in FIG. 2. Other formation methodologies can be employed without departing from the present concept. The projection 44 is then received in the receptacle 76, as at 118, to place the linkable element 10 in the connected configuration. At least the connector 20 is then received, as at 122, in another mold (not expressly depicted herein) having a cavity that corresponds with the outer surface of the layer of material 12, as is depicted in dashed lines in FIG. 7. Upon curing of the layer of material 12 that was formed by the introduction of molten material in such a mold, the linkable element 10 has been formed into the ring 2.

As is depicted generally in FIG. 9, another flowchart depicts other aspects in accordance with the disclosed and claimed concept that relate to the formation of a chain, such as the chain 8, that includes the ring 2. For instance, and as at 126, an end of the elongated body 16, such as the male portion 24 or the female portion 28, is received in a hole formed in each of a number of other structures. The projection 44 is then received in the receptacle 76 to place the linkable element 10 in its connected configuration, as at 130. At least the connector 20 is then received, as at 134, in another mold (as was indicated at 122) and the layer of material 12 molded onto the connector 20 to form the ring 2 connected with the other structures (such as the another structure 4) to form the chain 8

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. An element structured to be attached to another structure having a hole formed therein, comprising:
a connector comprising a first portion and a second portion that are connectable together;
an elongated body having as a first end the first portion and having as a second end the second portion, one of the first end and the second end being structured to be received in the hole formed in the another structure prior to connection with the other of the first end and the second end;
the connector being structured to receive a layer of material applied to an exterior thereof when the first and second portions are connected together; and
the body being structured to be of a ring-like configuration that is substantially continuous about its longitudinal extent when the first and second portions are connected together and the layer of material is received on the connector.

2. The element of claim 1 wherein the connecter is structured to receive as the layer of material a layer of material affixed to the exterior of the connecter.

3. The element of claim 1 wherein the body is formed of a polymeric material, and wherein the connecter is structured to receive as the layer of material a layer of the polymeric material molded to the exterior of the connecter.

4. The element of claim 3 wherein at least one of the first portion and the second portion comprises a number of engagement structures situated at the exterior of the connector and structured to have the layer of polymeric material molded thereto to resist relative movement between the layer of polymeric material and the at least one of the first portion and the second portion.

5. The element of claim 4 wherein:
one of the first portion and the second portion comprises a protrusion;
the other of the first portion and the second portion comprising a receptacle structured to receive at least a portion of the protrusion when the first and second portions are connected together;
the first portion comprising a number of first engagement structures situated at its exterior, and the second portion comprising a number of second engagement structures situated at its exterior; and
the receptacle and the protrusion being situated generally between at least a portion of the number of first engagement structures and at least a portion of the number of second engagement structures when the first and second portions are connected together.

6. The element of claim 1 wherein one of the first portion and the second portion comprises a protrusion, and wherein the other of the first portion and the second portion comprises a receptacle structured to receive at least a portion of the protrusion when the first and second portions are connected together.

7. The element of claim 6 wherein the connector comprises a number of retention structures situated on the protrusion and a number of further retention structures situated on the receptacle, and wherein at least some of the number of retention structures and at least some of the number of further retention structures are structured to confront one another when the first and second portions are connected together and to resist disconnection of the first and second portions.

8. A ring-like element comprising:
a connector comprising a first portion and a second portion;
an elongated body having as a first end the first portion and having as a second end the second portion, the first and second portions being connected together to cause the body to be of a ring-like configuration that is substantially continuous about its longitudinal extent; and
a layer of material situated on an exterior of the connecter and being structured to resist disconnection of the first and second portions.

9. The ring-like element of claim 8 wherein the connecter is structured to receive as the layer of material a layer of material affixed to the exterior of the connecter.

10. The ring-like element of claim 8 wherein the body is formed of a polymeric material, and wherein the layer of material is a layer of the polymeric material molded to the exterior of the connecter.

11. The ring-like element of claim 10 wherein at least one of the first portion and the second portion comprises a number of engagement structures situated at the exterior of the connector, the layer of polymeric material being molded to the number of engagement structures to resist relative movement between the layer of polymeric material and the at least one of the first portion and the second portion.

12. The ring-like element of claim 11 wherein:
one of the first portion and the second portion comprises a protrusion;
the other of the first portion and the second portion comprising a receptacle having at least a portion of the protrusion received therein;
the first portion comprising a number of first engagement structures situated at its exterior, and the second portion comprising a number of second engagement structures situated at its exterior; and
the receptacle and the protrusion being situated generally between at least a portion of the number of first engagement structures and at least a portion of the number of second engagement structures.

13. The ring-like element of claim 8 wherein one of the first portion and the second portion comprises a protrusion, and wherein the other of the first portion and the second portion comprises a receptacle in which at least a portion of the protrusion is received.

14. The ring-like element of claim 13 wherein the connector comprises a number of retention structures situated on the protrusion and a number of further retention structures situated on the receptacle, and wherein at least some of the number of retention structures and at least some of the number of further retention structures confront one another and are structured to resist disconnection of the first and second portions.

15. The ring-like element of claim 8 wherein at least one of the body and the layer of material has an indentation that is formed on an exterior surface thereof, the indentations extending about the body in an azimuthal direction that is disposed generally transverse to the longitudinal extent of the body and that is situated substantially at a junction between the body and the layer of material.

16. The ring-like element of claim 8 wherein the body comprises a first ledge which extends in an azimuthal direction that is disposed generally transverse to the longitudinal extent of the body, the first connector extending generally in a longitudinal direction away from the first ledge, and wherein the body comprises a second ledge which extends in an azimuthal direction that is disposed generally transverse to the longitudinal extent of the body, the second connector extending generally in a longitudinal direction away from the first ledge, the layer of material extending generally between the first and second ledges.

17. A chain of connected elements comprising the ring-like element of claim 8 that is linked-together with a number of other structures that have a hole formed therein, the ring-like element being received in the holes.

18. A method of attaching a ring-like element to another structure having a hole formed therein, comprising:
receiving through the hole one of a first end and a second end of an elongated body which has as the first end a first portion of a connector and which has as the second end a second portion of the connector;
connecting together the first and second portions; and
receiving on an exterior of the connected together first and second portions of the connector a layer of material to resist disconnection of the first and second portions.

19. The method of claim 18 wherein the connecting together of the first and second portions comprises receiving at least a portion of a protrusion that is formed on one of the first portion and the second portion in a receptacle that is formed on the other of the first portion and the second portion, and further comprising employing the layer of material to resist relative movement between the protrusion and the receptacle.

20. The method of claim 19 wherein the body is formed of a polymeric material, and wherein the receiving of the layer of material comprises molding a layer of the polymeric material onto the connected together first and second portions of the connector.

21. The method of claim 20 wherein the connector comprises a number of first engagement structures situated on the first portion and a number of second engagement structures situated on the second portion, the protrusion and the receptacle being situated generally between at least some of the number of first engagement structures and at least some of the number of second engagement structures, and wherein the molding of the layer of the polymeric material onto the connected together first and second portions further comprises molding the layer of the polymeric material onto the first and second engagement structures.
